(19) United States
(12) Patent Application Publication
(10) Pub. No.: US 2003/0190469 A1
(43) Pub. Date: Oct. 9, 2003

(54) Process for the surface modification treatment of polymer and products produced therefrom

(75) Inventors: Ru-Yu Wu, Tao-Yuan City (TW); Yue-Tang Lin, Taipei City (TW)

Correspondence Address: MORGAN, LEWIS & BOCKIUS LLP, 1111 Pennsylvania Avenue, NW, Washington, DC, 20004, US

(73) Assignee: Far Eastern Textile Ltd.

(21) Appl. No.: 10/189,733

(22) Filed: Jul. 8, 2002

(30) Foreign Application Priority Data
Mar. 21, 2002 (TW) 091105434

(51) Int. Cl. B32B 19/00

(52) U.S. Cl. 428/357

(57) ABSTRACT

The present invention provides a process for surface modification treatment of a polymer, and products produced therefrom, in which a polymer is subjected to a surface modification treatment using a sulfuryl chloride (SO₂Cl₂)-based solution, followed by employing a reaction terminating agent capable of decomposing or neutralizing sulfuryl chloride to terminate the surface modification treatment. A thus-obtained polymeric fiber or fabric exhibits excellent properties, such as moisture diffusion and wicking properties, anti-pilling property, dyestuff dyeability and the like.

### CROSS-REFERENCE TO RELATED APPLICATION

This application claims priority of Taiwan patent Application No. 091105434, filed on Mar. 21, 2002.

### BACKGROUND OF THE INVENTION

1) Field of the Invention

The present invention relates to a process for surface modification treatment of a polymer, and products produced therefrom. Specifically, according to the present invention, a polymer is subjected to a surface modification treatment using a sulfuryl chloride (SO₂Cl₂)-based solution, thereby improving the surface properties thereof, such as the dyestuff dyeability of a polymeric product, the moisture diffusion and wicking properties, the anti-pilling property and the full-dull property of a polymeric fiber or fabric, etc.

2) Description of the Related Art

In recent years, manufacturers in the textile industry are endeavoring to develop new fibers and/or fabrics having excellent color fastness property and moisture diffusion and wicking properties. In this regard, there have been developed a number of processes for the production of fibers and/or fabrics that exhibit good moisture diffusion and wicking properties. For example, Toyobo's PRH® 50 is a multi-layer yarn having a structure composed of an outer layer, a middle layer and an inner layer, and it is produced by a composite spinning process using hydrophilic cotton fiber(s), polyester-cotton mixed fiber(s) and polyester microfiber(s).

Another conventionally available technique for the production of a multi-layer fabric is based on the design of fabric structure, in which hydrophilic natural fiber(s) and hydrophobic synthetic fiber(s) are formed into a textile fabric having a two-layer or three-layer structure. For example, the Cool & Dry® textile fabric available from Kappa Co., Japan is manufactured by forming a fabric structure having an outer layer, a middle layer and an inner layer using synthetic fibers of different fineness, such that this fabric exhibits good moisture diffusion and wicking properties due to the capillary action of the multi-layer structure thereof.

There is a further conventional process which makes use of spinnerets of specific configurations to form hydrophobic fibers having different special cross-sectional configurations, e.g. tri-lobal, multi-lobal, cross-shaped, triangular and hollow configurations, etc., the thus-formed fibers exhibiting water-absorption ability as a result of the capillary action of the interfibre spaces thereof.

In addition to the aforesaid, there have been developed hollow microporous fibers, such as Wellkey® fibre available from Teijin Co., Japan, and water-absorbing fibers, such as Sophista® fiber available from Kuraray Co., Japan, which is developed from hydrophilic hydroxy-containing polymers (e.g., ethylene-vinyl alcohol-based material). The above processes share the following common drawbacks: complicated procedures in manufacture, limited choices of available fiber structures, and production of products that are water-absorbing but not moisture-wicking and have poor wash fastness.

In addition to the aforesaid, there are other techniques which improve the hydrophilicity of fibers and/or fabrics by various surface modification treatments, including, e.g. the technique of impregnating or padding a fiber or fabric with a surface modifier (such as a hydrophilic agent), in which the fiber or fabric is surface-modified by applying a hydrophilic softener to the surface thereof; the fiber modification process, in which a fiber is treated with a chemical reagent during the dyeing and finishing stage, such that the chemical structure of the fiber's surface is modified to include hydrophilic functional groups; the radiation processing of the surface of a fiber or fabric; the low temperature plasma jet processing of fibers, the grafting treatment of a fiber or fabric with a peroxide or persulfate compound, amongst others. The above processes share the following common drawbacks: high cost in manufacture, environmentally unfriendly, low efficiency in production, and the undesired impingement upon other properties of the treated fiber, which would occur in particular in the manufacture of fine denier fibers.

Further, in the prior art, a general process commonly employed to modify the surface hydrophobic nature of a polymeric fiber or fabric involves subjecting a fiber or fabric to a surface sulfonation reaction using gaseous sulfur trioxide (SO₃) as a sulfonating agent under a gaseous environment, optionally in combination with other gases such as carbon dioxide, chlorine gas, dichloromethane, air, oxygen gas and the like, and in the presence of a solvent, such as Oleum, chlorosulfonic acid (ClSO₃H) and the like, followed by neutralizing the remaining acidic sulfonating agent present on the surface of the fiber or fabric with a gaseous or liquid basic neutralizing agent (e.g. NH₃, NaOH and the like). The sulfonation treatment described above will cause a portion of hydrogen atoms that are attached to the carbon atoms present on the surface of the fiber or fabric under treatment to be replaced by SO₃⁻ ionic groups, thereby increasing the surface polarity of the treated fiber or fabric, while improving other properties of the same, such as the antistatic effect and the barrier effect. Such a technique of using a gaseous sulfonating agent has been fully disclosed in U.S. Pat. No. 3,959,561.

There are some other patents disclosing the modification treatments of polymeric products using SO₃-containing concentrated fuming sulfuric acid (xH₂SO₄.ySO₃) or chlorosulfonic acid (ClSO₃H) as a sulfonating agent under a liquid environment (see, e.g. the technical disclosure of U.S. Pat. No. 2,727,831).

In addition to the aforementioned patents, there are some patents disclosing that polymeric products could be modified by subjecting the same to sulfonating and neutralizing treatments under a gaseous or liquid environment (see, e.g. U.S. Pat. No. 2,400,720, U.S. Pat. No. 2,832,696, U.S. Pat. No. 2,937,066, U.S. Pat. No. 2,945,842, U.S. Pat. No. 3,592,724, U.S. Pat. No. 3,613,957, U.S. Pat. No. 3,625,751, U.S. Pat. No. 3,629,025, U.S. Pat. No. 3,740,258, U.S. Pat. No. 3,770,706, U.S. Pat. No. 3,947,539, U.S. Pat. No. 4,220,739, U.S. Pat. No. 4,615,914, U.S. Pat. No. 5,030,399). All of the patents and literature references cited above are hereby incorporated by reference in their entirety.

However, all of the above conventional modification treatments by gaseous sulfonation must be conducted within a sealed pressure vessel, and they need careful and complicate control of the adjustments of the operating conditions in use, such as the gas content inside the pressure vessel, the operating pressure and so forth. Notwithstanding, these conventional modification treatments still encounter the problem of poor safety in operation, and this problem is aggravated when concentrated fuming sulfuric acid or chlorosulfonic acid is used as the sulfonating agent, which will cause drastic chemical reactions and, thus, increase the danger in operation.

There is another conventional process which likewise employs sulfur trioxide (SO₃) as a sulfonating agent in admixture with an additional gas serving as an oxygen molecule source, such as oxygen gas, nitrogen monoxide or nitrogen dioxide, etc., while irradiating the mixture with an energy source, such as UV light, an electron bean, an inert gas radio frequency (RF) plasma, a corona discharge, gamma-ray radiation and the like, thereby generating free radicals to enable the onset of the sulfonication reaction. The aforementioned sulfonation modification process induced by the irradiation of an energy source has already been disclosed in U.S. Pat. No. 5,798,078 and U.S. Pat. No. 6,066,286 in detail. However, this process also encounters similar problems: the need of a sealed container to conduct the gaseous reaction, complicated procedures for operation, and high cost in manufacture due to the use of a light source equipment.

Summing up the aforesaid, the existing processes for the sulfonation modification treatment of polymeric fibers and/or fabrics share the following common drawbacks: poor safety in operation, high cost in manufacture due to the use of expensive equipment, and complicated procedures in operation.

It is further noted that there have been disclosed a variety of sulfonation processes which increase the surface polarity of polymeric articles (e.g. plastic bottles, containers and the like) or polymeric fibers via the grafting of SO₃⁻ ionic groups. These conventional processes, for the most part, were developed for the purposes of improving the surface properties of the treated polymeric products, such as antistatic effect, adhesion, barrier effect, hydrophilicity and the like. However, heretofore, the applicants are unaware of any patent and literature reference disclosing that the surface properties of a polymeric fiber or fabric, such as the moisture diffusion and wicking properties, the anti-pilling property and the dyestuff dyeability, etc., can be improved by sulfonation modification treatment. Nevertheless, how to improve the aforesaid properties is a significant problem in the development of new textile fabrics to date. Therefore, there exists a great need for manufacturers in the Textile Industry to develop a new process to improve the surface properties of polymeric fibers and/or fabrics, such as the moisture diffusion and wicking properties, the dyestuff dyeability and the anti-pilling property, in particular the latter one.

Furthermore, titanium dioxide (TiO₂) is commonly used for incorporation into PET fibers so as to reduce light reflection and transmission of said fibers. However, the cost of manufacture will be undesirably increased due to the high cost of TiO₂. in addition, high load of TiO₂ may bring about the problem of spinneret blockage and difficulty in spinning.

In view of the aforesaid, in light of the broad spectrum of applications of polymeric fibers, fabrics and articles in daily life, there exists a great need for manufacturers in industry to develop a new process for surface modification treatment of a polymeric fiber, fabric or article, which is easy and safe in operation and which is cost-efficient.

### SUMMARY OF THE INVENTION

In view of the drawbacks existing in the prior art, after conducting a number of experiments, the Applicants have successfully developed a new process for the surface modification treatment of a polymer, in which a polymeric fiber, fabric or article is subjected to a surface modification treatment using a sulfuryl chloride (SO₂Cl₂)-based solution, followed by employing a reaction terminating agent capable of decomposing or neutralizing sulfuryl chloride to terminate the surface modification treatment. A thus-obtained polymeric fiber, fabric or article exhibits excellent surface properties, such as the dyestuff dyeability of a polymeric product, and the moisture diffusion and wicking properties, the anti-pilling property and the full-dull property of a polymeric fiber or fabric, etc.

Accordingly, in the first aspect, the present invention provides a process for surface modification treatment of a polymer, comprising the steps of:

(a) subjecting a polymer to a surface modification treatment using a sulfuryl chloride (SO₂Cl₂)-based solution; and

(b) employing a reaction terminating agent capable of decomposing or neutralizing sulfuryl chloride to terminate the surface modification treatment.

Preferably, the polymer to be treated by the process according to this invention comprises a polymer selected from a group consisting of: polyethylene terephthalate (PET), polybutylene terephthalate (PBT), polytrimethylene terephthalate (PTT), poly-1,4-bis(hydroxymethyl)-cyclohexane terephthalate (PCT), poly-p-ethylene-oxy-benzoate (PEB), polyethylene naphthalate (PEN), poly(alkylene biphenyl-4,4′-dicarboxylate), poly(p-phenylene alkanedioate), poly(alkylene terephthalate), poly(ethylene alkylenedioxy-4,4′-dibenzoate), poly(ethylene alkylene-4,4′-dibenzoate), polyethylene decanedioate, polyglycollide, poly(2-oxyethoxacetyl), polypivalolacton polyester, polyethylene terephthalate/5-sulfoisophthalate copolymer, polyethylene terephthalate/poly(2-oxyethoxacetyl) copolymer, and polyethylene terephthalate/polyethylene decanedioate copolymer; a polyester copolymer composed of a bifunctional alcohol monomer (i) and a bifunctional acid monomer (ii), wherein the bifunctional alcohol monomer (i) is selected from ethylene glycol, 1,4-butanediol, 1,5-pentanediol, 1,6-hexanediol, diethylene glycol, 1,4-cyclohexanediol, 3-methyl-pentanediol, and 2-methyl-hexanediol, and wherein the bifunctional acid monomer (ii) is selected from propanedioic acid, butanedioic acid, pentanedioic acid, hexanedioic acid, heptanedioic acid, octanedioic acid, nonanedioic acid, decanedioic acid, cyclohexanedicarboxylic acid, terephthalic acid; polyolefins such as polyethylene (PE) and polypropene (PP); polystyrene; and combinations of the aforesaid polymers.

In a preferred embodiment of the present invention, the polymer to be treated by the process according to this invention comprises an aromatic polyester selected from a group consisting of PET, PBT, PTT, PCT and combinations thereof. Preferably, the polymer to be treated is an aromatic polyester selected from a group consisting of PET, PBT, PTT and PCT, in particular PET.

In another preferred embodiment of the present invention, the polymer to be treated by the process according to this invention comprises a polyolefin, in particular PE and/or PP.

The polymer to be treated by the process of this invention has a fiber fineness value ranging from 0.01 and 10^{d/f}, as expressed in a unit of denier/filament (d/f). Preferably, the polymer to be treated by the process of this invention has a fiber fineness ranging from 0.5 to 60^{d/f}.

Preferably, step (a) of the process of this invention is conducted at a temperature ranging from 10° C. to less than 70° C. In a preferred embodiment, step (a) is conducted at a temperature ranging from 30° C. to 60° C. More preferably, step (a) is conducted at 40° C.

Preferably, step (b) of the process of this invention is conducted at a temperature ranging from 10° C. to 100° C. In a preferred embodiment, step (b) is conducted at a temperature ranging from 20° C. to 80° C. More preferably, step (b) is conducted at 40° C.

Preferably, the reaction termination agent suitable for use in the process of this invention is selected from a group consisting of: water; an aqueous solution, alcohol solution or ether solution of a hydroxide, chloride, sulfate, nitrate or acetate salt of a metal selected from group IA metals, group IIA metals, group IIIA metals, group IVA metals, group IB metals, group IIB metals, group VIIB metals and group VIIIB metals; polyethylene imine and polypropylene imine.

In a preferred embodiment, the reaction termination agent is an aqueous solution of a metal salt compound selected from a group consisting of sodium hydroxide (NaOH), potassium hydroxide (KOH), sodium acetate (NaAc), sodium sulfate (Na₂SO₄), sodium chloride (NaCl), copper sulfate (CuSO₄), and combinations thereof. More preferably, said metal salt compound is sodium hydroxide. In another preferred embodiment, the reaction termination agent is water.

Optionally, the sulfuryl chloride-based solution further comprises glacial acetic acid or benzene. Preferably, the sulfuryl chloride-based solution used in step (a) contains sulfuryl chloride and glacial acetic acid in a ratio ranging from 1:9 to 9:1 (v/v). More preferably, the sulfuryl chloride-based solution contains sulfuryl chloride and glacial acetic acid in a ratio of 1:1 (v/v).

In another preferred embodiment, the sulfuryl chloride-based solution used in step (a) further comprises benzene as a diluent for sulfuryl chloride.

In the second aspect, the present invention provides a surface-modified polymeric fiber, fabric or article, which is produced from a polymeric fiber, fabric or article treated by a process described above.

A surface-modified polymeric fiber or fabric produced from the process according to this invention can be fabricated into a product selected from a group consisting of underwear, sportswear, leisurewear and bed linen.

The above and other objects, features and advantages of the present invention will be apparent with reference to the following detailed description of the invention.

### DETAILED DESCRIPTION OF THE INVENTION

The present invention relates to a process for surface modification treatment of a polymer, and products produced therefrom, in which a polymeric fiber, fabric or article is subjected to a surface modification treatment using a sulfuryl chloride (SO₂Cl₂)-based solution, followed by employing a reaction terminating agent capable of decomposing or neutralizing sulfuryl chloride to terminate the surface modification treatment. Thereafter, the treated polymeric fiber, fabric or article is washed. A thus-obtained polymeric fiber, fabric or article is found to exhibit excellent properties, such as the dyestuff dyeability of polymeric products, the moisture diffusion and wicking properties, the anti-pilling property and the full-dull property of polymeric fibers or fabrics, etc.

For example, the Applicants found from investigations that knitted fabrics treated by the process of this invention have significantly improved anti-pilling property as compared with those that yet have to undergo surface modification treatment. Almost all of knitted fabrics with different textures can meet the highest standard of the anti-pilling property test, so long as the operating temperature and the reaction time of the surface modification treatment are duly controlled.

The present surface modification process can be practiced only using simple chemical reaction equipments, and it is easy and safe to operate. Therefore, the process of this invention indeed has the advantages of low cost in manufacture, high safety in operation, and applicability for large-scale industrial production.

Although the actual reaction mechanism of the process according to this invention is yet to be known, a possible reaction mechanism may be that a sulfonation reaction is involved therein. The operating principle of the process of this invention is illustrated with reference to the following example, in which PET is subjected to the surface modification treatment:

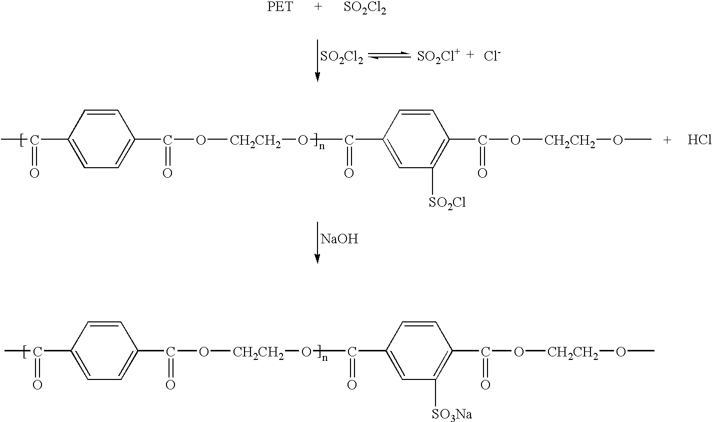

wherein sulfuryl chloride will be decomposed and bonded onto a benzene ring of the backbone of a PET polymer to replace a hydrogen atom which is bonded to a carbon atom of the benzene ring and exposed on the surface of the PET polymer (i.e. a sulfonatable hydrogen atom), followed by reacting with sodium hydroxide to thereby form a SO₃⁻ ion. As such, some SO₃⁻ anionic functional groups will be formed on the surface of the thus surface-modified polymer, thereby increasing the surface polarity of the polymer. Therefore, a polymer of poor dyeability, in particular in respect to cationic dyestuffs, can be modified to have improved dyeability due to the increased surface polarity thereof as a consequence of the surface modification treatment. Besides, due to the increase in surface polarity, the surface of the polymer will be modified from hydrophobic to hydrophilic, thus improving the moisture-absorbing property thereof.

Another possible operating principle of the process of this invention may be that sulfuryl chloride will corrode the surface of a polymer under treatment and result in the formation of numerous micropores on the surface of the polymer, thereby rendering the polymer to exhibit the excellent surface properties described above.

In addition, it is noted that a polymeric fiber, fabric or article treated by the surface modification process of this invention exhibits a good full-dull property.

The polymer to be treated by the process of this invention may comprise a polymer selected from a group consisting of: polyethylene terephthalate (PET), polybutylene terephthalate (PBT), polytrimethylene terephthalate (PTT), poly-1,4-bis(hydroxymethyl)-cyclohexane terephthalate (PCT), poly-p-ethylene-oxy-benzoate (PEB), polyethylene naphthalate (PEN), poly(alkylene biphenyl-4,4′-dicarboxylate), poly(p-phenylene alkanedioate), poly(alkylene terephthalate), poly(ethylene alkylenedioxy-4,4′-dibenzoate), poly(ethylene alkylene-4,4′-dibenzoate), polyethylene decanedioate, polyglycollide, poly(2-oxyethoxacetyl), polypivalolacton polyester, polyethylene terephthalate/5-sulfoisophthalate copolymer, polyethylene terephthalate/poly(2-oxyethoxacetyl) copolymer, and polyethylene terephthalate/polyethylene decanedioate copolymer; a polyester copolymer composed of a bifunctional alcohol monomer (i) and a bifunctional acid monomer (ii), wherein the bifunctional alcohol monomer (i) is selected from ethylene glycol, 1,4-butanediol, 1,5-pentanediol, 1,6-hexanediol, diethylene glycol, 1,4-cyclohexanediol, 3-methyl-pentanediol, and 2-methyl-hexanediol, and wherein the bifunctional acid monomer (ii) is selected from propanedioic acid, butanedioic acid, pentanedioic acid, hexanedioic acid, heptanedioic acid, octanedioic acid, nonanedioic acid, decanedioic acid, cyclohexanedicarboxylic acid, terephthalic acid; polyolefins such as polyethylene (PE) and polypropene (PP); polystyrene; and combinations of the aforesaid polymers.

Preferably, the polymer to be treated by the process of this invention comprises an aromatic polyester selected from a group consisting of PET, PBT, PTT and PCT, in particular PET. In a preferred embodiment, the polymer comprises a polyolefin, in particular PE and/or PP.

Objects that can be treated by the process of the present invention include polymeric fibers, polymeric fabrics and polymeric articles.

The polymeric fiber or fabric to be treated by the process of this invention may comprise a fiber having a fiber fineness value ranging from 0.01 to 10^{d/f} as expressed in a unit of denier/filament (d/f). Preferably, the polymer to be treated by the process of this invention comprises a fiber having a fiber fineness value ranging from 0.5 to 6.0^{d/f}.

The reaction termination agent suitable for use in the process of this invention may be selected from a group consisting of water; an aqueous solution, alcohol solution or ether solution of a hydroxide, chloride, sulfate, nitrate or acetate salt of a metal selected from group IA metals, group IIA metals, group IIIA metals, group IVA metals, group IB metals, group IIB metals, group VIIB metals and group VIIIB metals of the Elemental Periodic Table; polyethylene imine and polypropylene imine.

Preferably, the reaction termination agent comprises an aqueous solution of a metal salt compound selected from a group consisting of sodium hydroxide (NaOH), potassium hydroxide (KOH), sodium acetate (NaOAc), sodium sulfate (Na₂SO₄), sodium chloride (NaCl), copper sulfate (CuSO₄), and combinations thereof. In a preferred embodiment, an aqueous solution of sodium hydroxide is employed as the reaction terminating agent.

In another preferred embodiment, the reaction termination agent is water.

When a basic reaction termination agent is used in the process of this invention, it should be used at an appropriate concentration so as not to result in corrosion of the polymeric fiber or fabric under treatment. For example, when an aqueous solution of NaOH is used as the reaction termination agent, it preferably has a concentration failing within a range of about 0.1-20 wt %. More preferably, the concentration is about 0.5 wt %.

Optionally, in order to more effectively control the degree of the surface modification treatment and to ensure even treatment of the surface of a polymeric fiber, fabric or article, the sulfuryl chloride-based solution used in the process of this invention may further comprise an additional component that will not destroy the desired effect(s) of the present surface modification process, such as glacial acetic acid or benzene. In addition, if necessary, the operating time of the present surface modification process may be prolonged by adjusting the used amount of the additional component. When glacial acetic acid is used, the sulfuryl chloride-based solution preferably contains sulfuryl chloride and glacial acetic acid in a ratio ranging from 1:9 to 9:1 (v/v), more preferably in a ratio of 1:1 (v/v).

In another preferred embodiment, the sulfuryl chloride-based solution used in the process of this invention may further comprise benzene as a diluent.

The invention will now be described in more detail with reference to the following examples. However, it should be understood that these examples are given for the purpose of illustration only and are not intended to limit the scope of the present invention.

Materials:

1. Sulfuryl chloride (SO₂Cl₂): available from Riedel-Haën Co., CAS 7791-25-5 (purity>99%).

2. Glacial acetic acid: available from Riedel-Haën company, CAS 64-19-7 (purity>99.8% RG).

### EXAMPLE 1

Influences of Reaction Temperature and Reaction Time of the Surface Modification Treatment upon the Burst Strengths of Polymeric Fabrics

The surface modification treatment is conducted according to the following operating procedures in sequence:

(a) subjecting five samples of identical PET knitted fabrics (Topcool fabrics made of yarns of special cross section, manufactured by Far Eastern Textile Co., Ltd., fiber fineness 1.3^{d/f}) to a surface modification treatment by respectively immersing the same into a solution of sulfuryl chloride, wherein the respective reaction temperature and reaction time for each of the five samples are listed in Table 1;

(b) terminating the surface modification reaction by removing the treated knitted raw fabric samples from step (a) and immersing the same into a 0.5 wt % aqueous solution of NaOH at 25° C.; and

(c) removing the respective resultant knitted raw fabric samples from step (b) and washing the same with pure water at room temperature, followed by drying at 70° C. to remove water, thus obtaining the surface-modified PET knitted fabrics.

Bursting Strength Test

Procedures of Test:

The bursting strength test was conducted using a Mullen bursting strength tester according to the Mullen method, which includes the following operating procedures:

(a) clamping a fabric sample (15×15 cm²) onto the clamp (inner diameter=3.05±0.03 cm) of the tester in the presence of an even tension force at which no wrinkle or looseness of the fabric sample under test occurs;

(b) applying a pressure to the rubber diaphragm of the tester to gradually bulge the diaphragm, in which the oil supply of the hydraulic machine (pump) is increased at a rate of 98±4 ml/min in principle;

(c) respectively measuring the bursting strength value of the rubber diaphragm at which the tested fabric was burst by the diaphragm and the burst strength value of the rubber diaphragm at which the clamp was removed, in which the bursting strength value is expressed in a unit of lbf/in²; and

(d) calculating the average bursting strength value from five repetitions of identical fabric samples tested according to the aforesaid based on the following equation, in which the calculation was conducted up to the first decimal numeral:

Bursting strength (lbf/in²)=A−B

wherein,

A: the bursting strength value (in a unit of lbf/in²) of the rubber diaphragm at which the tested fabric sample was burst by the diaphragm; and

B: the bursting strength value (in a unit of lbf/in²) of the rubber diaphragm at which the clamp was removed.

The following Table 1 shows the average bursting strength values of the above five groups of fabric samples which had been subjected to different surface modification treatments under the reaction conditions listed in Table 1, respectively, as compared to that of the untreated group of identical fabric samples. A measured bursting strength value will be considered to fall within an acceptable range if it is greater than or equal to 40 lbf/in², a value commonly required by manufacturers in the industry, which is taken herein as a standard for evaluation.

TABLE 1
The bursting strength values of the surface-modified and
untreated PET knitted fabrics

| | | Surface modification treatment | | | | |
|---|---|---|---|---|---|---|
| Operating | | (Example 1) | | | | |
| temperature | | 50° C. | | | 40° C. | |
| Operating time | Untreated | 5 min | 10 min | 15 min | 5 min | 10 min |
| Bursting | 66 | 39 | 39 | 30 | 57.6 | 55.2 |
| strength* | | | | | | |

*in unit of lbf/in²

Results:

Referring to Table 1, the groups of fabric samples which were respectively subjected to the surface modification treatments for a period of 5 and 10 minutes at 40° C. are shown to have a bursting strength value of 39 lbf/in², which is very close to the standard value described above. As to the groups of fabric samples which were respectively subjected to the surface modification treatments for a period of 5 and 10 minutes at 50° C., the respective bursting strength values thereof (i.e. 57.6 and 55.2 lbf/in²) are greatly higher than the standard value.

It is clear from the above experimental data that the present surface modification process will not bring about undesired severe damage(s) to the bursting strength of a PET knitted fabric treated thereby. Given this, it is worthwhile to further investigate whether or not the present surface modification process may alter any property of a PET knitted fabric treated thereby, such as the moisture diffusion and wicking properties, the dyestuff dyeability, and in particular the anti-pilling property. Therefore, the following examples were conducted to determine the influences of the present surface modification process upon the dyestuff dyeability, the anti-pilling property and the moisture absorption property of the tested fabric samples.

### EXAMPLE 2

Termination of the Surface Modification Treatment Using Different Reaction Termination Agents at Different Starting Temperatures

The surface modification treatment was conducted along substantially the same procedures as described in Example 1, except that:

(a) several samples of identical PET woven fabrics (manufactured by Far Eastern Textile Co., Ltd., fiber fineness: 75d/36f for weft yarn and 150d/288f for warp yarn, respectively) were immersed into a solution of sulfuryl chloride at 40° C. for a period of 5 minutes; and

(b) the above surface modification reaction was terminated by using seven different reaction termination agents, the starting temperatures of which are varied from 20° C., 40° C. to 80° C., respectively.

After the surface modification treatment, the test samples were subjected to a CD dyeability test described below to evaluate the cationic dye (CD) dyeability thereof. The experimental conditions and the detected color differential value of each of the tested fabric samples are listed in the following Table 2.

CD Dyeability Test

Procedures of Test:

A 5% CD dye solution (blue color) was prepared at room temperature and heated to a temperature of 100° C., and the surface-modified and untreated PET woven fabrics were immersed into the dye solution at same temperature for an hour, respectively. Thereafter, the dyed woven fabrics were removed and washed, followed by drying, and then subjected to a colorimetric analysis.

Standards for Colorimetric Analysis:

The analysis was conducted using a COLOR AND COLOR DIFFERENCE METER (purchased from TOKYO DENSHOKU TECHNICAL CENTER). The dyeability of a dyed PET woven fabric was evaluated by comparing the color differential value (ΔE) thereof with that of a standard CD stockings band, which has a ΔE of 84.7.

TABLE 2
The color differential values (ΔE) of the surface-modified
and untreated PET woven fabrics

| | | Surface modified | | |
|---|---|---|---|---|
| Reaction | | Starting temperature of the reaction | | |
| termination | | terminating agent | | |
| agent (0.5 wt %) | Untreated | 20° C. | 40° C. | 80° C. |
| NaOH | 28.0 | 55.6 | 72.1 | 68.1 |
| | (very poor)* | (good) | (very good) | (very good) |
| KOH | 28.0 | 54.0 | 59.3 | 58.7 |
| | (very poor) | (good) | (good) | (good) |
| NaOAc | 28.0 | 50.0 | 58.9 | 52.2 |
| | (very poor) | (good) | (good) | (good) |
| Na₂SO₄ | 28.0 | 53.2 | 58.8 | 48.2 |
| | (very poor) | (good) | (good) | (good) |
| NaCl | 28.0 | 50.6 | 57.1 | 48.0 |
| | (very poor) | (good) | (good) | (good) |
| CuSO₄ | 28.0 | 55.0 | 56.5 | 46.3 |
| | (very poor) | (good) | (good) | (good) |
| H₂O | 28.0 | 47.9 | 61.8 | 51.2 |
| (100 wt %) | (very poor) | (good) | (good) | (good) |

*The degree of dyeability is shown in the parentheses

Results:

It can be seen from Table 2 that the non-surface modified PET woven fabric has a ΔE value of 28.0, indicating that the fabric has very poor dyeability since the employed cationic dyestuff can hardly be adhered thereto. In contrast, the surface modified samples of identical PET woven fabrics respectively have a ΔE value ranging from 46.3 to 72.1, indicating that the dyeability of each of these modified samples has been greatly enhanced. In general, all of the aqueous solutions of the tested reaction termination agents having a starting temperature of 40° C. are shown to provide a dyeing effect better than the same solution having a starting temperature of 20° C. or 80° C. In particular, the PET woven fabric, the surface modification of which was terminated by using the aqueous solution of NaOH having a starting temperature of 40° C., is shown to have the best dyeability.

### EXAMPLE 3

The Influence of the Surface Modification Treatment upon the Anti-Pilling Property of Fiber/Fabric

The surface modification treatment was conducted along substantially the same procedures as described in Example 1, except that: five different PET knitted fabrics (manufactured by Far Eastern Textile Co., the respective fabric texture and fiber fineness value of which are shown in Table 3) were subjected to the surface modification treatment, in which the operating temperature is maintained at 40° C., and the reaction time is either 5 minutes or 10 minutes. The experimental conditions of each of the tested samples are listed in Table 3.

Test of Anti-Pilling Effect

Procedures of Test:

The test was conducted according to the ASTM D3512 method. The test samples were cut in squares 105 mm on the bias at approximate 0.78 rad (45°) angle to the warp (wale) and filling (course) directions. The edges of all the test samples were sealed to a width not exceeding 3 mm on the face of the fabric with adhesive, and the test samples were hung on racks until dry, and in any case for at least 2 hour.

The thus prepared three pieces of test fabric samples and about 25 mg of 5 mm (0.2 in) gray-colored cotton fiber were placed into a test chamber, which was then run at a speed of 1,200 rpm for 30 minutes. After the running time, the test samples were removed out, and the excess cotton fiber that was not actually entangled in pills was cleaned off using a vacuum cleaner. Each of the test sample was firmly grasped by a corner so as to allow the vacuum suction to draw the test sample inside.

Rating Standards:

The experimental results of the anti-pilling test were visually classified into the following five rates:

| | |
|---|---|
| Rate 5 | no pilling |
| Rate 4 | slight pilling |
| Rate 3 | moderate pilling |
| Rate 2 | severe pilling |
| Rate 1 | very severe pilling |

in which rate 5 represents the highest rate having the best anti-pilling effect, i.e. a lowest amount of pills formed on the surface of a tested fabric.

The experimental results were expressed as an average of the determined rates of the three pieces of fabric samples.

Result:

Five knitted fabrics of different fabric textures were assessed in the anti-pilling test. It can be seen from Table 3 that for the knitted fabrics without surface modification treatment, their highest anti-pilling scales can only reach scale 2. However, when these knitted fabrics were surface modified, their anti-pilling scales can reach scale 4 or even the highest scale 5, indicating that the surface modified knitted fabrics exhibit excellent anti-pilling property.

TABLE 3
The anti-pilling effects of the surface modification
treatment upon different tested knitted fabrics

| | | | Hollow-shaped configuration | | | | Cross-shaped |
|---|---|---|---|---|---|---|---|
| | Yarn material | | | Terry | Single | | configuration |
| | Fabric texture | | Interlock | cloth | Jersey | PK | Single Jersey |
| | Fiber fineness | | 1.3^{d} | 150^{d} × 1.3^{d} | 1.3^{d} | 1.3^{d} | 1.3^{d} |
| Strength | Untreated | | 72 | 72 | 75 | 69 | 66 |
| | Surface | 5 min | 63 | 45 | 57 | 39 | 42 |
| | modified | 10 min | 48 | 42 | 54 | 36 | 36 |
| Anti-pilling | Untreated | | 1 | 1 | 1˜2 | 2 | 1 |
| scale | Surface | 5 min | 3 | 4˜5 | 4 | 3 | 4˜5 |
| | modified | 10 min | 4˜5 | 5 | 5 | 4˜5 | 5 |

### EXAMPLE 4

The Influence of the Surface Modification Treatment upon the Moisture-Absorption Property of Fiber/Fabric

The surface modification treatment was conducted along substantially the same procedures as described in Example 1, except that: a PET fiber and five PET fabrics (all of which were manufactured by Far Eastern Textile Co., and the respective fabric texture and fiber fineness value of which are shown in Table 3) were subjected to the surface modification treatment, in which the operating temperature is maintained at 30° C. or 60° C., and the reaction time is either 5 minutes or 10 minutes. The experimental conditions of each of the tested samples are listed in Table 4.

Moisture-Absorption Test

The experimental results of the moisture-absorption test are expressed as the moisture regain percentage of the tested fiber/fabric calculated according to the following equation:

Regain (%)=((W₁−W₀)/W₀)×100

W₀: the absolute dry weight of the sample after being dried in an oven of 80° C. for 12 hrs;

W₁: the weight of the moisture regained sample after being placed in an environment of 25° C. and 65% RH (relative humidity) for 6 hrs.

TABLE 4
The influence of surface modification treatment upon the
moisture-absorption property of fiber/fabric

| | | | Surface | Surface modification | |
|---|---|---|---|---|---|
| | Cross-sectional | Fiber | modification | time | |
| Fiber/fabric | configuration | fineness | temperature | 5 min | 10 min |
| Cross-shaped | Cross-shaped | 75^{d}/48^{f} | untreated | 1.293 | |
| fiber | | | 30° C. | 2.013 | 2.132 |
| | | | | (1.56 X) | (1.65 X) |
| | | | 60° C. | 2.068 | 2.530 |
| | | | | (1.60 X) | (1.96 X) |
| Woven fabric of | Round | Warp yarn = | Untreated | 0.593 | |
| filament yarn | | 75^{d}/36^{f} | 30° C. | 0.703 | 0.832 |
| | | Weft yarn = | | (1.19 X) | (1.40 X) |
| | | 150^{d}/288^{f} | 60° C. | 0.996 | 0.265 |
| | | | | (1.68 X) | (3.82 X) |
| Woven fabric of | Round | Waft yarn = | Untreated | 0.525 | |
| filament yarn | | 75^{d}/72^{f} | 30° C. | 1.106 | 1.318 |
| | | Weft yarn = | | (2.11 X) | (2.51 X) |
| | | 75^{d}/72^{f} | 60° C. | 2.149 | 2.248 |
| | | | | (4.09 X) | (4.28 X) |
| Woven fabric of | Round | Waft yarn = | Untreated | 0.748 | |
| filament yarn | | 75^{d}/36^{f} | 30° C. | 1.052 | — |
| | | Waft yarn = | | (1.41 X) | — |
| | | 150^{d}/288^{f} | 60° C. | 1.898 | |
| | | | | (2.54 X) | |
| Knitted | Round | 0.8^{d} | Untreated | 0.527 | |
| stockings band | | | 30° C. | 1.047 | 1.134 |
| of staple yarn | | | | (1.99 X) | (2.15 X) |
| | | | 60° C. | 1.197 | 1.282 |
| | | | | (2.27 X) | (2.43 X) |
| Knitted | Cross-shaped | 1.4^{d} | Untreated | 0.535 | |
| stockings band | | | 30° C. | 1.184 | 1.119 |
| of staple yarn | | | | (2.21 X) | (2.25 X) |
| | | | 60° C. | 1.627 | 1.709 |
| | | | | (3.04 X) | (3.19 X) |

*The magnitude of the moisture regain percentage of a surface modified sample to that of the corresponding untreated sample is shown in the parentheses.

Result:

The moisture regain percentages of the tested fibers and fabrics are recorded in Table 4, in which the respective magnitudes of the moisture regain percentages of surface modified samples (treated at either 30° C. or 60° C.) to those of the corresponding untreated samples are shown in parentheses. It is noted from the tested fibers and fabrics that the moisture-regain percentages of the tested samples, which had been subjected to the surface modification treatment at either 30° C. and 60° C., are higher than those of the corresponding untreated samples, respectively, indicating that the tested samples have been improved in terms of moisture-absorption property.

### EXAMPLE 5

The Surface Modification of PBT and PTT Fibers and the CD Dyeability of Said Fibers After Surface Modification

The surface modification treatment was conducted along substantially the same procedures as described in Example 1, except that:

(a) the samples to be surface modified include a PBT fiber (manufactured by Far-Eastern Textile Company, fiber fineness=150^{d}/74^{f}) and a PTT fiber (manufactured by Far-Eastern Textile Co., fiber fineness=150^{d}/144^{f}), and the samples were immersed in a sulfuryl chloride solution for 5 minutes at 40° C.

CD Dyeability Test

Procedures of dyeing: Conducted according to the procedures set forth in Example 2.

Standards for Colorimetric Analysis: Conducted according to the procedures set forth in Example 2.

TABLE 5
The color differential values (ΔE) of the surface-modified
and untreated fibers

| Types of polyester fibers | untreated sample | surface modified sample |
|---|---|---|
| PBT | 65.40 | 77.04 |
| PTT | 54.97 | 74.07 |

Result:

It can be seen from Table 5 that the ΔE values of the surface modified PBT and PTT fibers are increased, indicating that the surface modification treatment improves these fibers' dyeability.

### EXAMPLE 6

The CD Dyeability of PP Non-Woven Fabric After Surface Modification

The surface modification treatment was conducted along substantially the same procedures as described in Example 1, except that:

(a) the sample to be surface modified is a PP non-woven fabric (manufactured by Far-Eastern Textile Co., fiber fineness=2.4^{d}), and the sample was immersed in a sulfuryl chloride solution for 5 minutes at 40° C.; and

(b) a 0.5 wt % NaOH aqueous solution was used as the reaction termination agent, and the starting temperature thereof is 20° C.

CD Dyeability Test The procedures of dyeing and the calorimetric analysis were conducted according to those set forth in Example 2. The colorimetric ΔE values of the surface modified PP non-woven fabrics are shown in Table 6.

TABLE 6
The color differential values (ΔE) of the surface-modified
and untreated PP fabrics

| | | Surface modified | |
|---|---|---|---|
| | Untreated | 40° C., 5 min | 40° C., 10 min |
| ΔE | 3.92 | 37.20 | 37.52 |

Result:

In general, PP fibers are difficult to be dyed by any dyestuff. However, the results of this experiment shows that a PP non-woven fabric can become dyeable using cationic dyes after the surface modification treatment according to this invention. It is contemplated that the surface modified PP non-woven fabric is dyeable by dispersed dyestuffs as well.

In conclusion, the present invention provides a process for surface modification treatment of a polymeric product, such as a polymeric fiber, a polymeric fabric or a polymeric article, in which the polymeric product is surface modified by sulfuryl chloride (SO₂Cl₂) in a liquid environment, followed by employing a variety of reaction terminating agents capable of decomposing or neutralizing sulfuryl chloride to terminate the surface modification treatment, thereby obtaining a polymeric fiber, a polymeric fabric or a polymeric article exhibiting an excellent surface polarity. The present surface modification process overcomes the problems of poor safety and complicated procedures in operation that are normally associated with the conventional processes in which a gaseous reaction is involved. Therefore, the process of this invention has the potential for application in large-scale industrial production.

In addition, a polymeric fiber or fabric treated by the present surface modification process is found to exhibit excellent properties, such as the moisture diffusion and wicking properties, the anti-pilling property, the CD dyeability and the full-dull property. As such, the process of this invention is expected to have remarkable values in the Textile Industry.

All patents and literature references cited in the present specification are hereby incorporated by reference in their entirety. In case of conflict, the present description, including definitions, will prevail.

While the invention has been described with reference to the above specific embodiments, it is apparent that numerous modifications and variations can be made without departing from the scope and spirit of this invention. It is therefore intended that this invention be limited only as indicated by the appended claims.

We claim:

1. A process for surface modification treatment of a polymer, comprising the steps of:
(a) subjecting a polymer to a surface modification treatment using a sulfuryl chloride (SO₂Cl₂)-based solution; and
(b) employing a reaction terminating agent capable of decomposing or neutralizing sulfuryl chloride to terminate the surface modification treatment.

2. A process as defined in claim 1, wherein the polymer to be treated comprises a polymer selected from a group consisting of:
polyethylene terephthalate (PET), polybutylene terephthalate (PBT), polytrimethylene terephthalate (PTT), poly-1,4-bis(hydroxymethyl)-cyclohexane terephthalate (PCT), poly-p-ethylene-oxy-benzoate (PEB), polyethylene naphthalate (PEN), poly(alkylene biphenyl-4,4′-dicarboxylate), poly(p-phenylene alkanedioate), poly(alkylene terephthalate), poly(ethylene alkylenedioxy-4,4′-dibenzoate), poly(ethylene alkylene-4,4′-dibenzoate), polyethylene decanedioate, polyglycollide, poly(2-oxyethoxacetyl), polypivalolacton polyester, polyethylene terephthalate/5-sulfoisophthalate copolymer, polyethylene terephthalate/poly(2-oxyethoxacetyl) copolymer, and polyethylene terephthalate/polyethylene decanedioate copolymer; a polyester copolymer composed of a bifunctional alcohol monomer (i) and a bifunctional acid monomer (ii), wherein the bifunctional alcohol monomer (i) is selected from ethylene glycol, 1,4-butanediol, 1,5-pentanediol, 1,6-hexanediol, diethylene glycol, 1,4-cyclohexanediol, 3-methyl-pentanediol, and 2-methyl-hexanediol, and wherein the bifunctional acid monomer (ii) is selected from propanedioic acid, butanedioic acid, pentanedioic acid, hexanedioic acid, heptanedioic acid, octanedioic acid, nonanedioic acid, decanedioic acid, cyclohexanedicarboxylic acid, terephthalic acid; polyolefins such as polyethylene (PE) and polypropene (PP); polystyrene; and combinations of the aforesaid polymers.

3. A process as defined in claim 2, wherein the polymer to be treated comprises an aromatic polyester selected from a group consisting of PET, PBT, PTT, PCT, and combinations thereof.

4. A process as defined in claim 3, wherein the polymer to be treated comprises PET.

5. A process as defined in claim 3, wherein the polymer to be treated comprises PBT.

6. A process as defined in claim 3, wherein the polymer to be treated comprises PTT.

7. A process as defined in claim 2, wherein the polymer to be treated comprises a polyolefin selected from a group consisting of PE, PP, and combinations thereof.

8. A process as defined in claim 7, wherein the polymer to be treated comprises PP.

9. A process as defined in claim 1, wherein the polymer to be treated comprises a fiber having a fiber fineness value ranging from 0.01 to 10^{d/f} as expressed in a unit of denier/filament (d/f).

10. A process as defined in claim 9, wherein the polymer to be treated comprises a fiber having a fiber fineness value ranging from 0.5 to 6.0^{d/f} as expressed in a unit of denier/filament (d/f).

11. A process as defined in claim 1, wherein step (a) is conducted at a temperature ranging from 10 to less than 70° C.

12. A process as defined in claim 11, wherein step (a) is conducted at a temperature ranging from 30 to 60° C.

13. A process as defined in claim 12, wherein step (a) is conducted at 40° C.

14. A process as defined in claim 1, wherein step (b) is conducted at a temperature ranging from 10 to 100° C.

15. A process as defined in claim 14, wherein step (b) is conducted at a temperature ranging from 20 to 80° C.

16. A process as defined in claim 15, wherein step (b) is conducted at 40° C.

17. A process as defined in claim 1, wherein the reaction termination agent employed in step (b) is selected from a group consisting of water; an aqueous solution, alcohol solution or ether solution of a hydroxide, chloride, sulfate, nitrate or acetate salt of a metal selected from group IA metals, group IIA metals, group IIIA metals, group IVA metals, group IB metals, group IIB metals, group VIIB metals and group VIIIB metals; polyethylene imine and polypropylene imine.

18. A process as defined in claim 17, wherein the reaction termination agent is water.

19. A process as defined in claim 17, wherein the reaction termination agent is an aqueous solution of a metal salt selected from a group consisting of sodium hydroxide, potassium hydroxide, sodium sulfate, sodium chloride, copper sulfate, and combinations thereof.

20. A process as defined in claim 19, wherein the reaction termination agent is an aqueous solution of sodium hydroxide.

21. A process as defined in claim 1, wherein the sulfuryl chloride-based solution used in step (a) further comprises glacial acetic acid.

22. A process as defined in claim 21, wherein the sulfuryl chloride-based solution contains sulfuryl chloride and glacial acetic acid in a ratio ranging from 1:9 to 9:1 (v/v).

23. A process as defined in claim 22, wherein the sulfuryl chloride-based solution contains sulfuryl chloride and glacial acetic acid in a ratio of 1:1 (v/v).

24. A process as defined in claim 1, wherein the sulfuryl chloride-based solution employed in step (a) further comprises benzene.

25. A process as defined in claim 1, wherein the polymer is in a form selected from a group consisting of polymeric fibers, polymeric fabrics and polymeric articles.

26. A surface-modified polymeric fiber, which is produced from a polymeric fiber treated by a process as defined in claim 25.

27. A surface-modified polymeric fiber as defined in claim 26, wherein the polymeric fiber comprises a fiber having a fiber fineness value ranging from 0.01 to 10^{d/f} as expressed in a unit of denier/filament (d/f).

28. A surface-modified polymeric fiber as defined in claim 27, wherein the polymeric fiber comprises a fiber having a fiber fineness value ranging from 0.5 to 6^{d/f} as expressed in a unit of denier/filament (d/f).

29. A surface-modified polymeric fabric, which is produced from a polymeric fabric treated by a process as defined in claim 25.

30. A surface-modified polymeric fabric as defined in claim 29, wherein the polymeric fabric comprises a fiber fineness having a fineness value ranging from 0.01 to 10^{d/f} as expressed in a unit of denier/filament (d/f).

31. A surface-modified polymeric fabric as defined in claim 30, wherein the polymeric fabric comprises a fiber having a fineness ranging from 0.5 to 6.0^{d/f} as expressed in a unit of denier/filament (d/f).

32. A surface-modified polymeric fabric as defined in claim 29 fabricated into a product selected from a group consisting of underwear, sportswear, leisurewear and bed linen.

33. A surface-modified polymeric article, which is produced from a polymeric article treated by a process as defined in claim 25.
